(19) United States
(12) Patent Application Publication
(10) Pub. No.: US 2006/0064239 A1
(43) Pub. Date: Mar. 23, 2006

(54) Navigation device

(75) Inventor: Naoki Ishii, Handa-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/227,219

(22) Filed: Sep. 16, 2005

(30) Foreign Application Priority Data
Sep. 17, 2004 (JP) 2004-271051

(51) Int. Cl. G01C 21/26

(52) U.S. Cl. 701/200; 340/995.1

(57) ABSTRACT

A navigation device for navigating an operator of a vehicle to a destination by showing a path to the destination on a map includes a map display means, a information retrieval means, a information storage means, a current time retrieval means, an information comparison means, and a information notification means. The map display means displays a map. The regulation information retrieval means retrieves regulation information including a regulation area and a regulation time. The regulation information storage means stores the regulation information. The current time retrieval means retrieves a current time. The information comparison means determines whether the current time is within the regulation time. The information notification means notifies the operator of the regulation information in advance for an assessment of a precautionary measure.

### CROSS REFERENCE TO RELATED APPLICATION

This application is based on and claims the benefit of priority of Japanese Patent Application No. 2004-271051 filed on Sep. 17, 2004, the disclosure of which is incorporated herein by reference.

### FIELD OF THE INVENTION

The present invention generally relates to a navigation device for navigating a driver of a vehicle to a destination.

### BACKGROUND OF THE INVENTION

In recent years, a navigation device in an automotive vehicle is used by a driver for finding an optimum path to a travel destination with the assistance of a Global Positioning System (GPS). The navigation system detects a current location of the vehicle, displays the optimum path on a map in a display, and emits a guidance sound or a voice for suitably assisting a driving operation of the vehicle.

Information on traffic regulations, traffic jams and the like are typically available on signboards along a freeway, radio program, or telephone services. However, each of these measures has their own restrictions. For example, signboards cannot be seen from a distant location, radio programs cannot be broadcast on demand, and telephone services may only serve traffic information about freeways. The driver of the vehicle may think it is necessary to obtain traffic information on demand that also includes cause of the traffic regulation/control/jam and a prospect of relief therefrom. Japanese Patent Document JP-A-H05-120596 discloses a one method of retrieving traffic information on demand.

Alternatively, Japanese Patent Documents JP-A-H10-141975 and JP-A-H11-132776 discloses a navigation information generated by a navigation device that is fine-tuned to provide traffic information regarding specific driving regulations and controls, such as one-way road restrictions, right/left turn restrictions and the like. The navigation information further privides driving regulations for specifically defined periods, such as certain days of the week. Lastly, the navigation information provides a shortest travel route to the destination based on a given condition of traffic regulations/restrictions.

The navigation information generated by a conventional navigation device sometimes includes routing information that is only valid for a specifically defined period, such as certain days of the week. For example, the routing information is not useful for the driver when a portion of a road in a navigation route can only be traveled in summer, or when the portion of the road in the navigation route is closed during a time slot that includes the expected time of arrival of the vehicle. Japanese Patent Document JP-A-2000-028377 discloses a method to cope with the above-described problems. That is, the availability of a road under certain restrictions is reflected in a navigation device for finding the optimum route to the destination. Therefore, the driver can receive advance notice of restrictions, such as road closures for a day of the week, for a time, or for a season of the year. The user can also receive notice that the expected arrival time coincides with the time of the traffic regulation, or a notice that a destination facility is closed before the vehicle arrives at the expected arrival time.

Furthermore, these conventional navigation devices may provide information based on temporal road closures, traffic jams, or detours around construction sites by incorporating information from various sources. However, the information on these types of traffic conditions may not be available prior to travel. In such a case, the driver may find him/herself forced to cope with the restrictions. This may lead to an inconvenience of the driver such as an extended travel time to the destination, or a delay to an appointed time.

### SUMMARY OF THE INVENTION

In view of the above-described and other problems, the present invention provides a navigation device that communicates traffic regulations to a driver of a vehicle in advance for an assessment of a precautionary measure.

The navigation device of an embodiment of the present invention includes a map display device for displaying a map and a recommended route to a travel destination. The navigation device further includes an information retrieval function, an information storage function, a current time retrieval function, an information comparison function and an information notification function. The navigation device having the above-described components and functions retrieves traffic regulation information that includes a regulation time and a regulation area with the information retrieval function before the vehicle starts to the travel. The navigation device then stores the retrieved regulation information with the information storage function. Then, the navigation device identifies the current time by the current time retrieval function. Then, the navigation device compares the current time and the regulation time with the information comparison function. This comparison is for determining whether the current time is within a predetermined period before a start time of the regulation. If the current time is determined to be within the predetermined period, the navigation device notifies the driver of the regulation information with the information notification function.

The navigation device notifies the driver of the traffic regulation information in a route to the destination in advance, thereby allowing the driver to suitably plan an alternative route that takes the regulation time and area into account. In this manner, the navigation device improves safety in driving and contributes to prevention of accidents.

The navigation device includes a network connection function to retrieve the regulation information from an external network. The retrieved information is stored with the information storage function for the improvement of driving condition. The navigation device retrieves and stores the information without the driver's operation, and thereby improves the driving condition in terms of automation of the retrieval operation.

The navigation device includes a voice data retrieval function and a voice data recognition function. The driver uses the voice data retrieval function to verbally input the regulation information shown on a signboard or the like while driving. The voice data, that is, verbal information on traffic regulations, is recognized by the voice data recognition function and the recognized information is stored by the information storage function. In this manner, the navigation device accepts verbal information of traffic regulations, thereby improves the driving condition in terms of automation of the input operation.

The navigation device includes a voice data storage function for notifying the driver of the regulation information by voice. The voice data on the regulation information stored in the voice data storage function is used by the information notification function to verbally provide the regulation information to the driver in a less distracting manner compared to the regulation information in an image shown on the display.

The navigation device includes a device condition determination function for detecting a change in a device condition. The device condition determination function detects a turning on/off of the navigation device. The navigation device notifies the driver of the stored information of traffic regulations when the navigation device is turned on or turned off by using the device condition determination function. In this manner, the navigation device allows the driver to receive the regulation information before the vehicle reaches the regulation area, or before starting the travel to the destination. An advance notice of the regulation information gives the driver time to assess an alternative route and/or an alternative travel plan based on expected traffic regulations.

The navigation device includes a current location detection function, an arrival time estimation function and a time comparison function. The navigation device uses these functions to determine whether the vehicle reaches the regulation area in the range of regulation time. An arrival time of the vehicle to the regulation area is notified differently when the arrival time is within the range of the regulation time. In this manner, the driver can determine urgency of the traffic regulation.

The navigation device includes a distance calculation function to determine whether the regulation area is within a predetermined distance from the current location of the vehicle. The navigation device displays the regulation area on the map when the regulation area is determined within the predetermined range of distance. In this manner, the driver of the vehicle can take possible traffic jams by the regulation into account, and can use a different route or the like.

The navigation device further includes a routing function and a regulation scope comparison function. The regulation scope comparison function detects the regulation area/regulation time in a route to the destination determined by the routing function. Therefore, the navigation device takes the regulation area and the regulation time into consideration when it determines the route to the destination. That is, the navigation device uses a normal route to guide the driver to the destination when there is no regulation area, and the navigation device finds a detour from the normal route when there is a regulation area and/or a regulation time in the route to the destination. In other words, the navigation device routes the travel of the vehicle to the destination after considering the traffic regulations/restrictions in a time-conscious manner.

### BRIEF DESCRIPTION OF THE DRAWINGS

Other objects, features and advantages of the present invention will become more apparent from the following detailed description made with reference to the accompanying drawings, in which:

FIG. 1 is a block diagram of the navigation device of the present invention;

FIG. 2A is an example of an advance notice setting screen for regulation information stored in the navigation device 100;

FIG. 2B is an example of an area setting and a voice setting screen for the regulation information stored in the navigation device 100;

FIG. 3 is an example of a regulation area specified in the map;

FIG. 4 is a flowchart for storing the regulation information in an e-mail;

FIG. 5 is a flowchart of notification of the regulation information at a time of turning on the navigation device;

FIG. 6 is a flowchart of notification of the regulation information at a time of turning off the navigation device;

FIG. 7A is an example of an advance notice button on a display;

FIG. 7B is an example of the regulation information on the display;

FIG. 8 is a flowchart of display process of the regulation information; and

FIG. 9 is an illustration of routing by a detour around the regulation area.

### DETAILED DESCRIPTION OF THE PREFERRED EMBODIMENTS

A navigation device of the present invention is described with reference to the drawings. An embodiment of the navigation device is used in an automotive system that notifies the driver of traffic regulations such as a closure of a road because of a scheduled construction or the like. The navigation device retrieves information on the traffic regulations prior to a travel to a destination, and communicates the information to a driver of a vehicle in a timely manner.

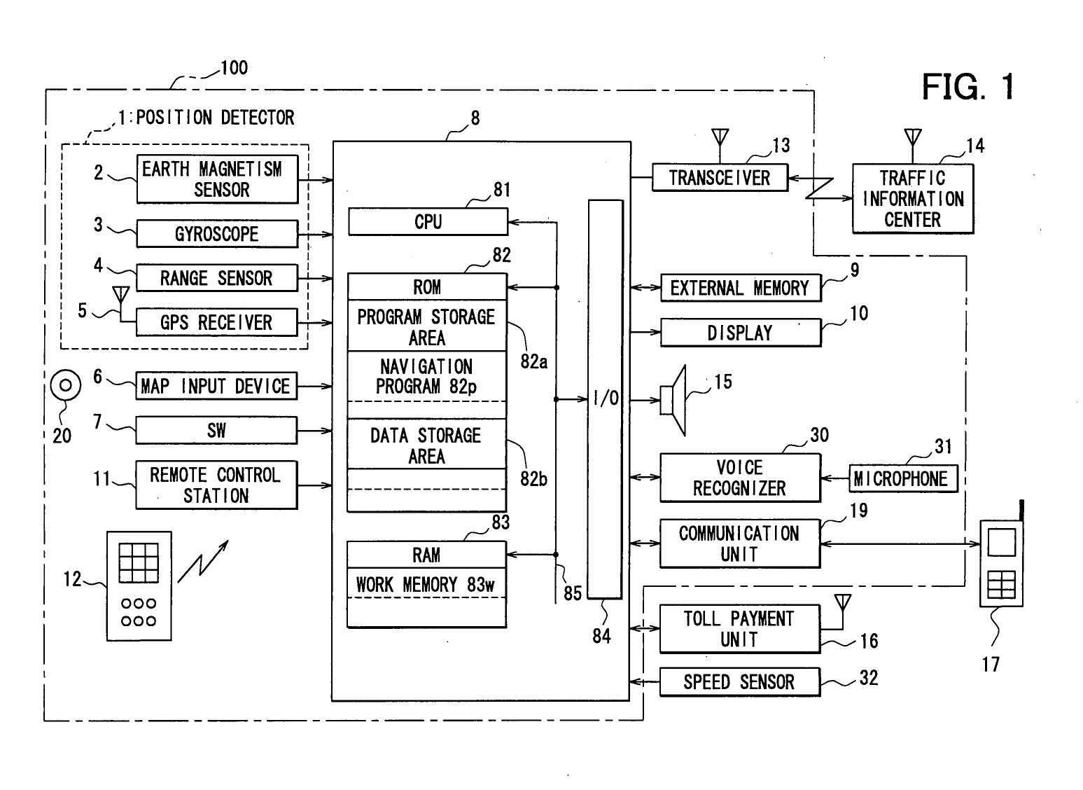

FIG. 1 shows a block diagram of the navigation device of the present invention. The navigation device 100 includes a position detector 1, a map input device 6, switches 7, a control circuit 8, an external memory 9, a display 10, a remote control station 11, a remote controller 12, and a speaker 15.

The position detector 1 further includes a well-known type earth magnetism sensor 2, a gyroscope 3, a range sensor 4, and a GPS receiver 5 for receiving GPS signals from a satellite for position detection. These sensors in the position detector 1 have their own errors of different nature in position detection. These sensors in the position detector 1 compensate the errors in the position data by communicating with each other. These sensors may be used independently, or may be used with other sensors such as a steering rotation sensor, a wheel rotation sensor or the like.

The map input device 6 is used to input map data having attributes of roads and the like from a memory medium 20 for increased accuracy based on a map matching. The memory medium 20 for the map data comes in a form of a CD-ROM, a DVD-ROM, a Hard Disk Drive, or a memory card. The memory medium 20 may also be used as other type of storage.

The switches 7 are, for example, disposed on the display 10. The switches 7 may be touch switches, mechanical switches or the like. The touch switches on the display 10 uses infrared sensors to detect a position of the touching object for receiving an input. The switches 7 may be an input mouse of a computer system, or other type of pointing devices. The switches 7 and the remote controller 12 are used to give various instructions to the navigation device 100.

A voice recognizer 30 may also be used to give instructions. A microphone 31 connected to the voice recognizer 30 receives a voice of the driver, and the voice is processed by using a voice recognition technology such as hidden Markov model, a frequency analysis, a differential analysis, a liner algebraic technology, a spectral distortion, or a time warp method. The recognized voice is used as a command to control the navigation device 100.

The display 10 has a color liquid crystal display for displaying a vehicle location mark, whose location is calculated based on information retrieved from the position detector 1, a map data available from the map input device 6, and a route to the destination. The display 10 also displays menu buttons for advance notice of the regulation information, navigation guidance, and other operations.

A transceiver 13 is used to communicate with a traffic information center 14 for retrieving traffic information. The retrieved information is processed by the control circuit 8.

A cell phone 17 or a communication unit 19 can also be used to communicate with an external network for information retrieval. Further, a remote toll payment unit 16 may be used for information retrieval into the navigation device 100. The remote toll payment unit 16 communicates with the external network. The remote toll payment unit 16, the cell phone 17, and the communication unit 19 may be used to communicate with the traffic information center 14 for information retrieval.

The control circuit 8 includes a well-know type CPU 81, a ROM 82, a RAM 83, and an I/O 84 with a bus line 85 as a connecting circuit. The CPU 81 processes a program and data in the ROM 82 and the RAM 83. The ROM 82 includes a program storage area 82a and a data storage area 82b. The program storage area 82a stores a navigation program 82p. The data storage area 82b stores data for the navigation program 82p. The navigation program 82p uses a work memory 83w in the RAM 83. The function of the ROM 82 and the RAM 83 may be realized by using a hard disk drive when the map input device 6 uses the hard disk drive.

The external memory 9 stores data and information required for the operation of the navigation device 100. The external memory 9 retains the data and the information while the navigation device 100 is turned off.

The navigation device 100 described above operates in the following manner. That is, the control circuit 8 uses the CPU 81 to execute the navigation program 82p. Then, the navigation device 100 accepts an input by the switches 7, remote controller 12 or the microphone 31 from the driver of the vehicle. In this manner, the driver selects a desired operation from a menu displayed in the display 10. The display 10 displays the route to the travel destination when the driver selects, for example, a “NAVIGATION” item in the menu. That is, when the driver specifies the destination in the map on the display 10, an optimum route to the destination is searched and displayed on the display 10 with the map based on a current location of the vehicle calculated by GPS signal received by the GPS receiver 5 for navigating the driver. Search for the optimum route to the destination is executed by Dijkstra method or the like. At least one of the speaker 15 and the display 10 is used to communicate messages being dependent on an operation context from the navigation device 100 to the driver while the driver is using the navigation device 100.

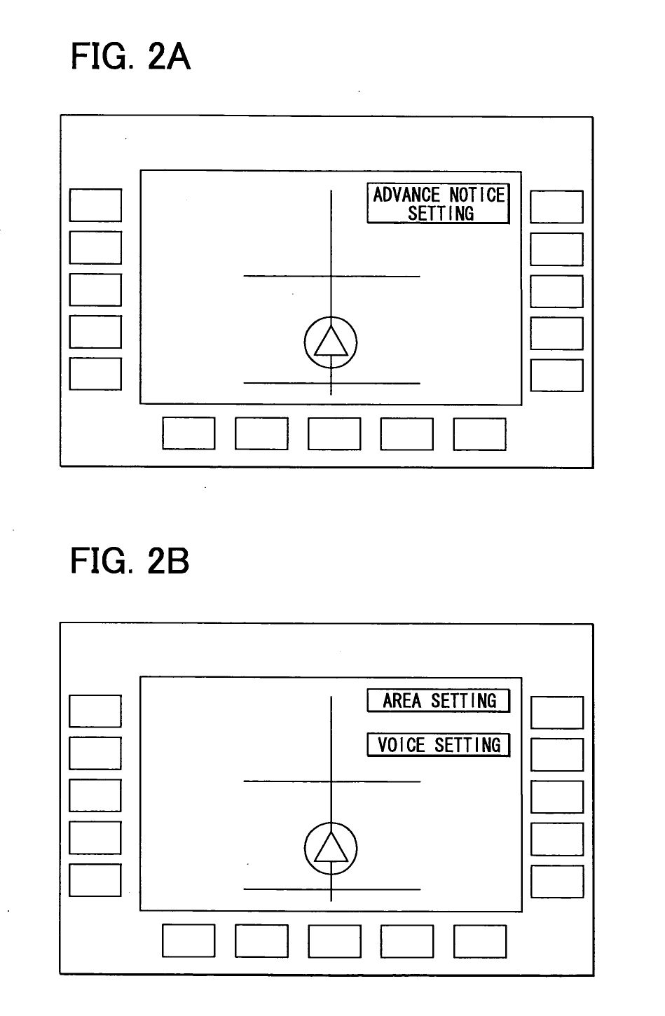

FIGS. 2A and 2B show examples of advance notice setting screens on the display 10. An “Advance Notice Setting” button is displayed in the screen as shown in FIG. 2A when the driver selects an item in the menu by using switches 7, the remote controller 12 or the voice captured by the microphone 31. When the “Advance Notice Setting” button is pressed in the screen, an “Area Setting” button and a “Voice Setting” button appear in another screen as shown in FIG. 2B. In this case, white squares around the screen are mechanical switches 7, and a triangle in a circle indicates a vehicle location mark that shows the current location of the vehicle.

Pressing the “Area Setting” button in FIG. 2B enables the driver to store traffic regulation information with the assistance of the guidance message displayed in the screen or voiced from the speaker 15. The traffic regulation information includes regulation type, regulation area, regulation time and the like. For example, the regulation type may be inputted from a regulation type input screen displayed on the display 10. A “Next” button in the regulation type input screen displays a regulation area input screen. The “Next” button in the regulation area input screen displays a regulation time input screen. The input operation concludes with a confirmation screen that displays all of the inputted contents of the regulation information, and the inputted content is stored in the external memory 9 when, for example, a “Confirmed” button in the screen is selected.

The regulation area is specified either by a direct input of a name such as a location name, a facility name, an intersection name, a bridge name, a tunnel name, an exit name or the like, or by search through listings of the names such as a listing of facilities, telephone numbers, addresses or the like.

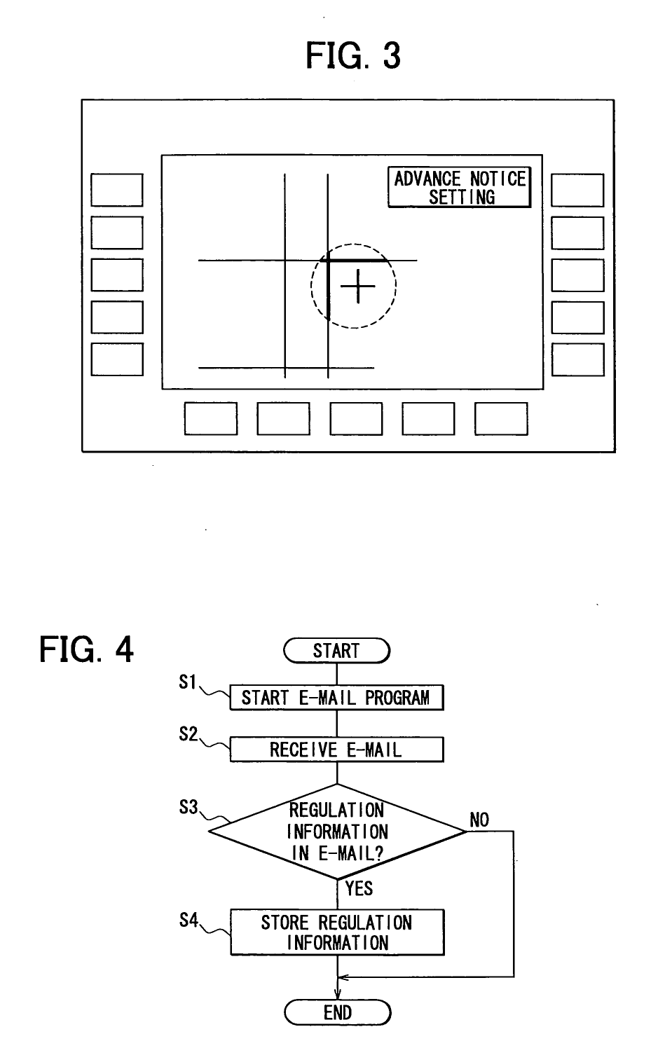

The regulation area may be specified by using the map on the display 10. FIG. 3 shows an example of a regulation area specified in the map. The regulation area is indicated by a heavy line portion of the road in a dotted circle having a cross hair cursor at its center. The radius of the circle may be changed by the driver.

The traffic regulation information may be retrieved from an external facility such as a traffic information center through a network connection to the navigation device 100. FIG. 4 shows a flowchart for storing the traffic regulation information received by an e-mail in the navigation device 100. The e-mail is received either by the transceiver 13, by the remote toll payment unit 16, or by the cell phone 17. The content of the e-mail is analyzed to determine whether the regulation type, the regulation area, the regulation time and the like are contained therein. The e-mail for the traffic regulation information may have a title “Traffic Regulations,” or may have the regulation type on a first line and the regulation area on a second line of a message body of the e-mail for distinction.

The e-mail may be determined to be including the traffic regulation information when the navigation device 100 demands the driver a PIN (a personal identification number) code.

An e-mail program is started in step S1 in FIG. 4 and the e-mail is received in step S2. When the e-mail is determined to have the traffic regulation information in step S3 (step S3:Yes), the message body of the e-mail is analyzed to extract, for example, the regulation type, the regulation area, and the regulation time for storage in the external memory 9 in step S4.

The navigation device 100 may notifies the driver of completion of the storage of the regulation information by a message on the display 10 or by the voice from the speaker 15.

The traffic regulation information received in a form of the e-mail may be inputted in the navigation device 100 by manually inputting a necessary portion of the information. The content of the regulation may be inputted by using the switches 7, by using the remote controller 12, or by using the voice captured by the microphone 31. In this manner, the content of the regulation can be checked in the course of operation, and only the required portion of the regulation information is inputted.

Further, the traffic regulation information may be filtered for the required portion of information with the filtering setting a “range” of the type, the area, and/or the time of the regulation. For example, the “range” of the regulation area may be limited to the routes between a home and an office of the driver. The range of the regulation area may be stored in the external memory 9 of the navigation device 100 for use in the advance notice setting screen. Contents of the traffic regulation information in the e-mail may be selectively chosen for each of the recipient, i.e., each of the navigation systems, in the traffic information center according to an appropriate range of the regulation type, the regulation area, and/or the regulation time for each navigation system. In this manner, only the required traffic regulation information is store in the external memory 9 of the navigation device 100. The reduction of the regulation information stored in the external memory 9 leads to a reduction of production cost, and prevents a delay of decision caused by unnecessary information.

The traffic regulation information may be created by using a personal computer with a compatible or a same type of map data as used in the navigation device 100. The created regulation information may be transferred to the navigation device 100, or may be stored in a memory medium such as a CD-ROM to be inputted and stored in the external memory 9 of the navigation device 100 by using the map input device 6.

The “Voice Setting” button in FIG. 2B is used to record the voice of the driver. The driver uses this button, for example, to record the traffic regulation information that is displayed on the signboard along a road and voiced with his/her voice as voice data. The voice data is stored in the external memory 9. The content of the voice data may be confirmed by using a “Playback” button not shown in the figure. In this manner, the driver can safely store and confirm the content of the traffic regulation information stored as the voice data. The voice data may be associated with other regulation information previously stored in the external memory 9.

The recorded voice may be analyzed by the voice recognition technology for recognizing and extracting the regulation type, the regulation area, and/or the regulation time in the voice recognizer 30. The extracted regulation information may be stored in the external memory 9 as regulation data.

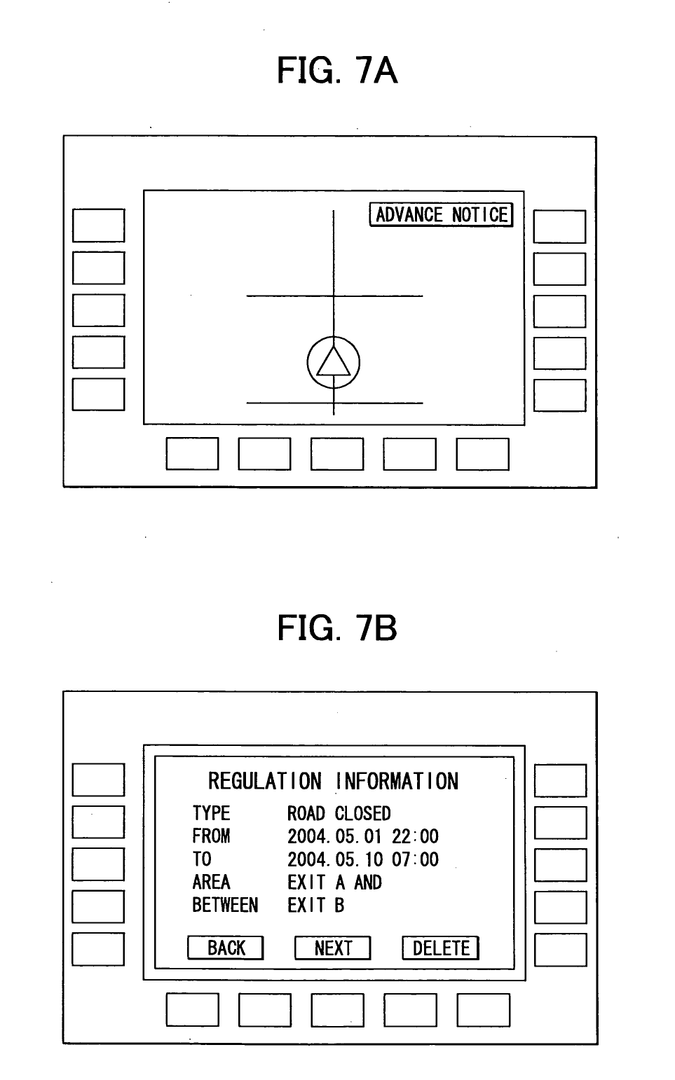

The traffic regulation information stored in the navigation device 100 can be confirmed by pressing a “Confirmation” button displayed with the buttons in FIG. 2B. Pressing the “Confirmation” button displays a list of regulation information entries stored in the navigation device 100. The content of each entry can be displayed when the driver select one of the entries displayed as a button in the screen. The content of one of the entries is displayed as shown in FIG. 7B. The voice data associated with the content may be played back for confirmation. The content may be changed by using the switches 7, the remote controller 12, or the voice captured by the microphone 31.

Contents of the external memory 9 may be modified when it is filled with the traffic regulation information. The traffic regulation information past due date may be automatically erased from the external memory 9. The content of the external memory 9 may be modified and/or erased according to predetermined conditions such as the distance from the home of the driver, the number of remaining days for the regulation time.

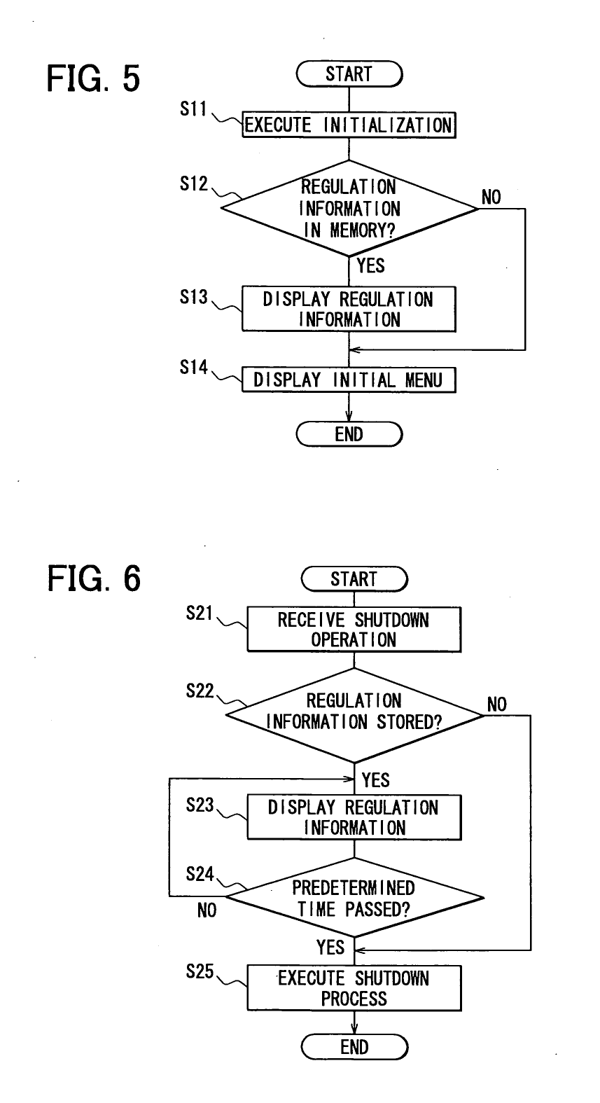

FIG. 5 shows a flowchart of notification process of the traffic regulation information when the navigation device 100 is turned on. The process of notification starts with an initialization of the device 100 in step S11. The process determines whether the regulation information is stored in the external memory 9 in step S12. When the regulation information is not stored in the memory 9 (step S12:No), the display 10 displays an initial menu in step S14.

When the regulation information is stored in the memory 9 (step S12:Yes), the “Advance Notice” button appears in the screen as shown in FIG. 7A (step S13). Pressing the “Advance Notice” button in the screen displays the content of the traffic regulation information (scheduled regulations) as shown in FIG. 7B. Pressing a “Back” button in the screen displays the screen shown in FIG. 7A again. A “Next” button in FIG. 7A may be displayed in the screen when there are plural entries of the traffic regulation information. Pressing the “Next” button displays a subsequent entry of the regulation information. The voice data associated to the entry is played back when the entry has one. The unnecessary regulation information such as past-due information will be deleted from the external memory 9 by pressing a “Delete” button in the screen in FIG. 7B. Pressing the “Back” button in FIG. 7B displays the initial menu of the navigation device 100 with the “Advance Notice” button on the display 10 in step S14.

FIG. 6 shows a flowchart of the regulation information notification process when the navigation device 100 is turned off. That is, a shutdown operation is received by the navigation device 100 in step S21. The process determines whether the traffic regulation information is stored in the external memory 9. When the traffic regulation information is not stored in the memory 9 (step S22:No), the shutdown process of the navigation device 100 is executed in step S25. The “Advance Notice” button is displayed in step S23, when the traffic regulation information is stored in the memory 9.

The navigation device 100 starts the shutdown process in step S25 when there is no input to the navigation device 100 for more than a predetermined period after the “Advance Notice” button is displayed on the screen in step S23 as shown in FIG. 7A. The navigation device 100 also starts the shutdown process when no input is recognized after the screen returns to the one shown in FIG. 7A by pressing the “Back” button. The predetermined period before shutting down the navigation device 100 may be changed by the driver or other users. In this manner, battery consumption by the navigation device 100 may be suppressed.

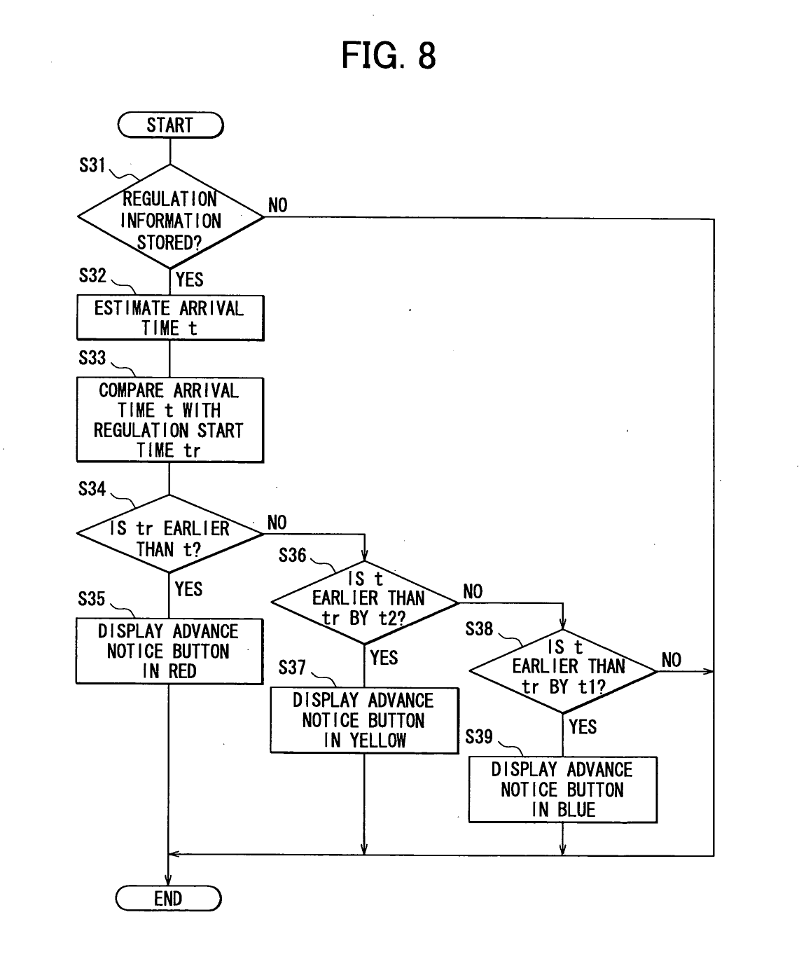

FIG. 8 shows a flowchart of traffic regulation information display process while the vehicle is traveling. This process is iterated by the navigation program 82p along with other processes. The navigation device 100 in operation always displays the “Advance Notice” button in the screen of the display 10 as shown in FIG. 7A when the device has the traffic regulation information stored in the external memory 9. The background color of the “Advance Notice” button is white, and the text color of the button is black.

The display setting of the “Advance Notice” button may be changed by the driver. That is, the “Advance Notice” button may not be displayed on the screen. The driver can change the display setting with an input to the menu (shown in FIG. 2A) by using the switches 7, the remote controller 12, or the voice captured by the microphone 31. The display setting is stored in the external memory 9.

A popup window in the screen may be used to display the traffic regulation information when the vehicle approaches to the regulation area in the map displayed on the display 10. That is, the popup window having the content of the regulation information may be displayed when the vehicle is within a predetermined range from the regulation area.

The regulation information display process starts as a determination step whether the traffic regulation information is stored in the device 100 in step S31. When the regulation information is stored in the device 100 (step S31:Yes), an estimated arrival time t to the regulation area is calculated based on a distance to the regulation area in step S32. The arrival time t can be calculated by adding an estimated travel time to the regulation area to the current time. The estimated travel time may be calculated, for example, by using a fixed travel speed (40 km/h for a local street and 80 km/h for a freeway), or by detecting the current speed of the vehicle with a speed sensor 32 having a rotary encoder or the like. Further, the estimated travel time may be calculated based on an average speed of the vehicle over a certain period.

The display process compares the estimated arrival time t with the regulation start time tr in step S33. When the regulation time is not found in the regulation information, the midnight (i.e., 0 a.m.) may be used as a start time of the regulation.

The “Advance Notice” button in FIG. 7A is displayed on the display 10 in step S35 when the regulation start time tr is determined to be earlier than the arrival time t in step S34 (S34:Yes). The background color of the “Advance Notice” button is red and the text color of the button is black. In this situation, the vehicle is expected to reach the regulation area after the regulation start time.

The “Advance Notice” button in FIG. 7A is displayed on the display 10 in step S37 when the estimated arrival time t is determined to be earlier than the regulation start time tr by an amount of t2, e.g., 30 minutes or smaller, in step S36 (S36:Yes). The background color of the “Advance Notice” button is yellow and the text color of the button is black. In this situation, the vehicle may reach the regulation area before the regulation start time, or may reach there after the regulation start time, depending on the traffic condition.

The “Advance Notice” button in FIG. 7A is displayed on the display 10 in step S39 when the estimated arrival time t is determined to be earlier than the regulation start time tr by an amount of t1, e.g., 120 minutes or greater, in step S38 (S38:Yes). The background color of the “Advance Notice” button is blue and the text color of the button is black. In this situation, the vehicle reaches the regulation area before the regulation start time with high probability.

The process shown in FIG. 8 handles all entries of the regulation information stored in the external memory 9 at the time of traveling. The entry having the red “Advance Notice” button occupies a highest priority of display with subsequent priorities of entries having the yellow button and the blue button. That is, the “Advance Notice” button in FIG. 7A is displayed in red when, for example, two regulation information entries having the red button and the blue button respectively correspond to the condition of display in the screen at the same time.

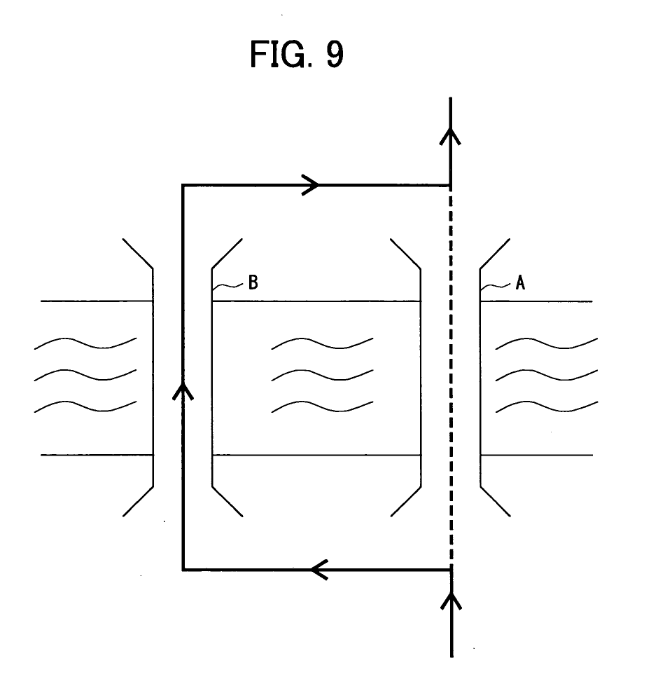

An example of routing based on an expected traffic regulation is shown in FIG. 9. The routing in FIG. 9 is a navigation route over a bridge on a river. A shortest route to a destination (normal route search) is shown as a dotted path on bridge A. The navigation device 100 stores the regulation information about bridge A, and does not store the regulation information about bridge B. As is already explained with reference to FIG. 8, the expected arrival time t to the bridge A is calculated based on the distance from the current location of the vehicle to the bridge A. Then, the arrival time t is compared with the regulation start time tr.

The navigation route is detoured to a nearest bridge B as shown in a solid line in FIG. 9 when the arrival time t is determined to be later than the regulation start time, or the arrival time t is determined to be earlier than the regulation start time by only an amount of t2 (e.g., 30 minutes) or smaller. The navigation route is not detoured when the arrival time t is determined to be earlier than the regulation start time by an amount of t1 (e.g., 120 minutes) or greater. The navigation device 100 may allow the driver to choose the route from either of the bridge A route or the bridge B route after displaying a notice to the driver when the arrival time t is earlier than the regulation start time by an amount of t2 (30 minutes) or smaller.

The navigation route to the destination on the other day can be searched by inputting the day of the travel to the navigation device 100. The navigation device 100 finds a route to the destination with a detour when a regulation is expected in the shortest route during the scheduled time of travel.

The date data and the time data are acquired from a RTC (Real Time Counter) included in the control circuit 8. Further, the date and time may be acquired from GPS signals received by the GPS receiver 5, other devices on the vehicle, or from other resources or facilities outside of the vehicle connected by a communication network.

Although the present invention has been fully described in connection with the preferred embodiments thereof with reference to the accompanying drawings, it is to be noted that various changes and modifications will become apparent to those skilled in the art.

Such changes and modifications are to be understood as being within the scope of the present invention as defined by the appended claims.

What is claimed is:

1. A navigation device for a vehicle comprising:
a map display means for displaying a map and a route on a display;
an information retrieval means for retrieving regulation information including a regulation area, a regulation time and a regulation start time;
an information storage means for storing the regulation information;
a current time retrieval means for retrieving a current time;
an information comparison means for determining whether the regulation start time is within an attentive period that is defined as a predetermined range of time succeeding the current time; and
an information notification means for transmitting the regulation information when the regulation start time is within the attentive period.

2. The navigation device according to claim 1 further comprising a network connection means for connecting the navigation device an external device,
wherein the regulation information is retrieved from the external device by using the network connection means.

3. The navigation device according to claim 1 further comprising:
an audio data retrieval means for retrieving audio data; and
an information extraction means for extracting the regulation information from the audio data.

4. The navigation device according to claim 3 further comprising an audio data storage means for storing the audio data,
wherein the information notification means transmits the audio data stored by the audio data storage means.

5. The navigation device according to claim 1 further comprising a device condition determination means for determining an ON/OFF status of the navigation device,
wherein the information notification means is used to transmit the regulation information when the status of the navigation device is switched from one of ON and OFF to the other in the attentive period.

6. The navigation device according to claim 1 further comprising:
a current location detection means for detecting a current location of the vehicle;
an arrival time estimation means for estimating an arrival time of the vehicle to the regulation area; and
a time comparison means for comparing the arrival time and the regulation time,
wherein the information notification means transmits the regulation information to the operator in a first form when the arrival time is within the regulation time, and
the information notification means transmits the regulation information to the operator in a second form when the arrival time is not within the regulation time.

7. The navigation device according to claim 6,
wherein a characteristic of the second form of the regulation information changes depending on an amount of time between the arrival time and the regulation start time.

8. The navigation device according to claim 6 further comprising a distance calculation means for calculating a travel distance from the current location to the regulation area,
wherein the map display means displays the regulation information on the map when the travel distance is within a predetermined range of values.

9. The navigation device according to claim 6 further comprising:
a routing means for determining a route to the destination; and
a route comparison means for comparing the route with the regulation area,
wherein the routing means adjusts the route to the destination when the route found by the routing means contains the regulation area and the regulation time contains the arrival time.

10. The navigation device according to claim 9,
wherein the routing means finds a detour around the regulation area.

11. A method for navigating a vehicle to a destination by displaying a route comprising the steps of:
providing a display for displaying a map and the route;
retrieving regulation information including a regulation area, a regulation time and a regulation start time;
storing the regulation information;
retrieving a current time;
determining whether the regulation start time is within an attentive period that is as a predetermined range of time succeeding the current time; and
transmitting the regulation information when the regulation start time is within the attentive period.

12. The method according to claim 11 further comprising the steps of:
retrieving audio data including the regulation information; and
extracting the regulation information from the audio data.

13. The method according to claim 12 further comprising the step of storing the audio data prior to extracting the regulation information therefrom.

14. The method according to claim 11 further comprising the steps of:
determining an ON/OFF status of the navigation device; and
transmitting the regulation information when the status of the navigation device is switched from one of ON and OFF to the other in the attentive period.

15. The method according to claim 11 further comprising the steps of:
detecting a current location of the vehicle;
estimating an arrival time of the vehicle to the regulation area;
comparing the arrival time and the regulation start time;
transmitting the regulation information in a first form when the arrival time is within the regulation time; and
transmitting the regulation information to the operator in a second form when the arrival time is not within the regulation time.

16. The method according to claim 15 further comprising the step of changing a characteristic of the second form of the regulation information depending on an amount of time between the arrival time and the regulation start time.

17. The method according to claim 15 further comprising the steps of:
calculating a travel distance from the current location to the regulation area; and
displaying the regulation information on the map when the travel distance is within a predetermined range of values.

18. The method according to claim 15 further comprising the steps of:
determining a route to the destination;
comparing the route with the regulation area; and
adjusting the route when the route contains the regulation area and the regulation time contains the arrival time.
